(19) United States
(12) Patent Application Publication
(10) Pub. No.: US 2026/0050174 A1
(43) Pub. Date: Feb. 19, 2026

(54) REDUCING AN IMPACT OF BACKWARD LIGHT ON LASER COMBINER RELIABILITY WITH SCATTERING ELEMENTS

(71) Applicant: Lumentum Operations LLC, San Jose, CA (US)

(72) Inventors: Vincent PETIT, Cupertino, CA (US); Matthew KUTSURIS, Dublin, CA (US); Gongwen ZHU, San Jose, CA (US); Richard D. FAULHABER, San Carlos, CA (US)

(21) Appl. No.: 18/944,333

(22) Filed: Nov. 12, 2024

Related U.S. Application Data
(60) Provisional application No. 63/684,619, filed on Aug. 19, 2024.

(51) Int. Cl. G02B 27/12; G02B 6/04

(52) U.S. Cl. CPC G02B 27/12; G02B 6/04

(57) ABSTRACT

A light combiner assembly includes a plurality of fibers that form a fiber bundle, and are configured to combine light from a plurality of respective light sources into forward propagating light; and a capillary tube that includes a tube body that defines an internal tube volume in which the plurality of fibers is arranged. The tube body includes a non-tapered section, including a first longitudinal end arranged proximate to respective unstripped sections of the fibers, and a tapered section, including a second longitudinal end, arranged around respective stripped sections of the fibers and to which the respective stripped sections are fused. The tapered section tapers from a first tube diameter to a second tube diameter. The tube body includes one or more scattering elements configured to scatter backward propagating light. The one or more scattering elements are incorporated into one or more materials of the tube body.

### CROSS-REFERENCE TO RELATED APPLICATION

This patent application claims priority to U.S. Provisional Patent Application No. 63/684,619, filed on Aug. 19, 2024, and entitled “REDUCING AN IMPACT OF BACKWARD LIGHT ON LASER COMBINER RELIABILITY.” The disclosure of the prior application is considered part of and is incorporated by reference into this patent application.

### TECHNICAL FIELD

The present disclosure relates generally to laser combiners and to laser combiners with reduced impact of backward light.

### BACKGROUND

Scaling the output power of lasers can be accomplished by increasing pump power. In the case of a fiber laser or a free space laser for continuous wave or pulsed laser applications, pumps may be combined using fiber combiners. Depending on the type of laser and laser architecture, several types of combiners can be used, including pump and pump signal combiners. In the case of a kilowatt (KW) fiber laser, combiners can be used for forward pumping and/or backward pumping. Another approach to scale the output power of lasers involves combining multiple lasers together using signal combiners.

### SUMMARY

In some implementations, a light combiner assembly includes a plurality of fibers that form a fiber bundle, wherein the plurality of fibers have respective unstripped sections and respective stripped sections, wherein the plurality of fibers are configured to receive light from a plurality of respective light sources and combine the light into forward propagating light; and a capillary tube that includes a tube body that defines an internal tube volume in which the plurality of fibers is arranged, wherein the tube body includes a non-tapered section, including a first longitudinal end arranged proximate to the respective unstripped sections, and a tapered section, including a second longitudinal end, arranged around the respective stripped sections and to which the respective stripped sections are fused, wherein the tapered section tapers from a first tube diameter of the non-tapered section to a second tube diameter of the second longitudinal end, wherein the tube body includes one or more scattering elements configured to scatter backward propagating light, and wherein the one or more scattering elements are incorporated into one or more materials of the tube body.

In some implementations, a light combiner assembly includes a plurality of fibers that form a fiber bundle, wherein the plurality of fibers have respective unstripped sections and respective stripped sections, wherein the plurality of fibers are configured to receive light from a plurality of respective light sources and combine the light into forward propagating light; and a non-tapered capillary tube that includes a first tube body that defines a first internal tube volume in which the plurality of fibers is arranged, wherein the respective stripped sections are fused to the first tube body, wherein the first tube body includes a first longitudinal end arranged proximate to the respective unstripped sections, and a second longitudinal end, wherein the first tube body includes one or more scattering elements configured to scatter backward propagating light, and wherein the one or more scattering elements are incorporated into one or more materials of the first tube body; and a tapered capillary tube that includes a second tube body that defines a second internal tube volume, wherein the second tube body is spliced to the second longitudinal end of the first tube body for receiving the forward propagating light from the non-tapered capillary tube.

### BRIEF DESCRIPTION OF THE DRAWINGS

FIG. 1A shows a light combiner assembly according to one or more implementations.

FIG. 1B shows a light combiner assembly according to one or more implementations.

FIG. 1C shows a light combiner assembly according to one or more implementations.

FIG. 2A shows a light combiner assembly according to one or more implementations.

FIG. 2B shows a light combiner assembly according to one or more implementations.

FIG. 3 shows cross-sections of example capillary tubes.

FIG. 4 shows cross-sections of example capillary tubes.

FIG. 5 shows cross-sections of example capillary tubes.

FIG. 6 shows a light combiner assembly according to one or more implementations.

### DETAILED DESCRIPTION

The following detailed description of example implementations refers to the accompanying drawings. The same reference numbers in different drawings may identify the same or similar elements.

Challenges in designing components of a laser system may be independent of the type(s) of combiner being used. For example, because multiple fibers from multiple laser diodes or from different laser diodes are coupled to one output fiber, challenges arise in connection with packing fibers while maintaining the quality of a beam at an output of a combiner. The optical quality of a beam at an output of a combiner is mostly related to the brightness, and thus the numerical aperture (NA), of light exiting the combiner. The brightness of a combiner may be affected by the manner in which fibers from the laser diodes are packed together.

To control brightness while minimizing losses, fibers from the laser diodes may be packed together, fused, and then tapered down. A tapered end of the combiner may be spliced to an output fiber. The process of packing the fibers should be predictable and repeatable to achieve consistent combiner manufacturing. Accordingly, glass capillary tubes may be used to hold the fibers together. Thus, the fibers from the laser diodes may be bundled together and inserted inside a capillary tube that will preserve the shape of the bundle. The fibers may be stripped over a certain length prior to being inserted in the capillary tube. The stripped fibers may be fused with the capillary tube, which is then tapered down to match the dimensions of the output fiber.

Using a fiber combiner preserves brightness, but may allow any backward light to propagate back through the capillary tube, causing reliability issues. The backward light may be any unwanted light that propagates backward through the capillary tube, and may include reflected light or light generated from another source. For example, unwanted backward propagating light may include pump light, signal light, laser light, backward reflection light, backward scattered light, amplified light, an amplified spontaneous emission (ASE), a stimulated Raman scattering (SRS), and/or a stimulated Brillouin scattering (SBS). In such a case, the capillary tube used in the combiner may act as a waveguide for the backward light. Light propagating backward in the capillary tube may generate unwanted heating. In some cases, the backward light may interact with unstripped portions of the fibers, which may cause a heat to be concentrated at the unstripped portions of the fibers. For example, if backward light guided in the capillary tube reaches the unstripped portions of the fibers, the backward light may interact with the fibers, which may burn or damage the fiber coatings of the unstripped portions of the fibers.

In some cases, an outermost surface of the capillary tube may be etched or structured to force light to escape the capillary tube. Such external stripping methods may enable the stripping of high-NA light. However, light with lower NAs that does not interact with the outermost surface of the capillary tube as much as high-NA light may not be stripped using a conventional cladding light stripper. Thus, such external stripping methods are ineffective at stripping backward light to prevent damage to the fiber coatings of the unstripped portions of the fibers. Moreover, a conventional cladding light stripper may provide insufficient light stripping for some capillary tubes, such as silica tubes with fluorine-doped silica on an inner surface.

Some implementations described herein use light stripping elements, such as absorbers and/or scatterers, that are incorporated into one or more materials of a combiner to control where unwanted backward light will interact. In some implementations, the light stripping elements may include one or more absorbers that are incorporated into one or more materials of the combiner. In some implementations, the light stripping elements may include one or more scattering elements that are incorporated into one or more materials of the combiner. Absorption or scattering may generate heat at regions at which the light stripping elements interact with the unwanted backward light, but the heat can be localized and controlled based on a placement of the light stripping elements within the one or more materials of the combiner. In such a case, a housing for the combiner may be configured to dump the generated heat. For example, the combiner may be arranged on a cold plate that is configured as a heat sink.

In some implementations, the light stripping elements may disperse heat along a length of the combiner, the heat being caused by the light stripping elements interacting with the backward propagating light. In some implementations, the light stripping elements make up at least one of the one or more materials of the combiner. The combiner may be a capillary tube that is configured to bundle and fuse fibers together, and to combine light from each fiber into forward propagating light for producing combined light.

In some implementations, a capillary tube may have features that will absorb or scatter backward light. For example, absorption may be achieved using dopants, such as ions, that will absorb the backward light. In some cases, two or more different dopants may be used to target different wavelengths of light. Doping a base material, such as glass, of the capillary tube may allow stripping of light with lower NA, which is not usually stripped using an external stripping method. In some implementations, one or more absorbers used in the capillary tube are able to absorb any unwanted backward propagating light. In some implementations, the one or more absorbers may have a broad absorption band. In some implementations, for absorbing around 1 micrometer (μm), TiO₂, Cr₂O₃, and CoO, in combination with other dopants, may be used; however, other dopants may be used.

In some implementations, the one or more absorbers may be arranged in a ring within the capillary tube, or as an insert or an inclusion in the capillary tube. Any geometry for the one or more absorbers may be used. However, a configuration of the one or more absorbers may affect an absorption coefficient. The absorption coefficient may be optimized by adjusting a length of the capillary tube that is doped, a concentration level of an absorber, and/or a size or area in which the one or more absorbers are provided.

Additionally, or alternatively, scattering may be achieved by changing the density or porosity of the material of the capillary tube to form scattering elements or scattering structures. For example, a density of the capillary tube may be changed along a radial dimension of the capillary tube. As an example, a layer incorporated or embedded into the capillary tube along the length of the capillary tube may have a different density and/or porosity than a density and/or porosity of a base material, such that the density and/or porosity of the capillary tube changes in a radial dimension of the capillary tube. The difference in densities may act as a scattering structure or scattering boundary. The scattering boundary may extend along the length of the capillary tube, or portions thereof. In this way, a location at which light interacts with one or more scattering elements within the capillary tube can be controlled. Heat that is generated can be addressed through a design of the capillary tube.

Incorporating one or more scattering elements into the capillary tube may allow stripping of light with lower NA, which is not usually stripped using an external stripping method. In some implementations, one or more scattering elements used in the capillary tube are able to scatter any unwanted backward propagating light. In some implementations, the one or more scattering elements may be arranged in a ring within the capillary tube, or as an insert or an inclusion in the capillary tube. Any geometry for the one or more scattering elements may be used. However, a configuration of the scattering elements may affect a scattering coefficient. The scattering coefficient may be optimized by adjusting a length of the capillary tube, a density gradient of the capillary tube, and/or a size or area in which the one or more scattering elements are provided.

In some implementations, doped layers can be deposited during the fabrication of the tubes using a chemical vapor deposition system, such as modified chemical vapor deposition (MCVD), vapor axial deposition (VAD), outside vapor deposition (OVD), plasma chemical vapor deposition (PCVD), or the like. These processes may be used for producing capillary tubes and glass rods that are then drawn to fibers. For example, layers of doped silica may be deposited on the outer surface of a target/tube (e.g., using OVD or VAD) or on the inner surface of a glass substrate tube (e.g., using MCVD or PCVD). By controlling the flows of the precursors and the process parameters (e.g., temperature, carrier gas, or the like), the concentration of the dopants can be controlled radially and longitudinally along the length of the capillary tube. At this stage, the tube outer diameter (OD) is usually not suitable to be used, as is, to build combiners (e.g., >10 millimeters (mm)). Accordingly, the capillary tube can be pre-collapsed and/or stretched directly on a lathe, or drawn to capillaries using a draw tower. Here, the capillary tube may be fed in a furnace and pulled while controlling its inner pressure. Processes other than OVD, VAD, MCVD or PCVD may be used to fabricate glass layers with various dopants.

For the use of inserts, doped rods may be produced using similar vapor deposition processes. The doped rods may then be stacked with other rods prior to being drawn to capillaries. Moreover, the inserts may be inserted into the capillary tube, which can be drilled prior to drawing.

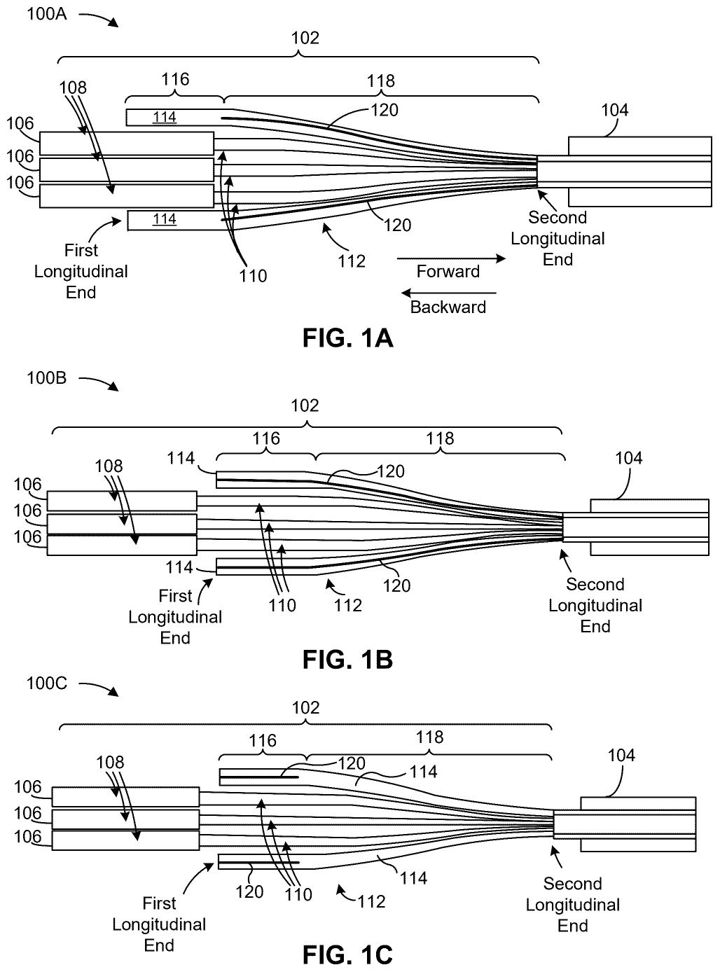

FIG. 1A shows a cross-section of a light combiner assembly 100A taken along a longitudinal axis according to one or more implementations. The light combiner assembly 100A may include a combiner 102 and an output fiber 104 that is spliced to the combiner 102 for receiving forward propagating light traveling in a forward propagating direction (e.g., from left-to-right). In addition, the combiner 102 may receive backward propagating light from the output fiber 104 that travels in a backward propagating direction (e.g., from right-to-left). The combiner 102 may be a signal combiner.

The combiner 102 may include a plurality of fibers 106 that form a fiber bundle. The plurality of fibers may have respective unstripped sections 108 and respective stripped sections 110. Additionally, the plurality of fibers 106 are configured to receive light from a plurality of respective light sources and combine the light into the forward propagating light.

The combiner 102 may include a capillary tube 112 that includes a tube body 114 that defines an internal tube volume in which the plurality of fibers 106 is arranged. The tube body 114 may include a non-tapered section 116, including a first longitudinal end arranged proximate to the respective unstripped sections 108, and a tapered section 118, including a second longitudinal end, arranged around the respective stripped sections 110 and to which the respective stripped sections 110 are fused. The tapered section 118 may taper from a first tube diameter of the non-tapered section 116 to a second tube diameter of the second longitudinal end such that the second tube diameter matches or substantially matches a diameter of the output fiber 104. The second longitudinal end may be spliced to the output fiber 104. In some implementations, instead of being spliced to the output fiber 104, the second longitudinal end may be spliced to a second capillary tube spliced to the second longitudinal end for providing the forward propagating light to the second capillary tube. An end of the second capillary tube opposite to the capillary tube 112 may be spliced to the output fiber 104.

In some examples, the plurality of fibers 106 may be inserted into the internal tube volume such that the respective unstripped sections 108 are arranged inside the internal tube volume. Thus, the non-tapered section 116 may be arranged around the respective unstripped sections 108. In other examples, the plurality of fibers 106 may be inserted into the internal tube volume such that the respective unstripped sections 108 remain outside of the internal tube volume.

The tube body 114 may include one or more light stripping elements 120 configured to interact with backward propagating light to reduce an amount of the backward propagating light that reaches the respective unstripped sections 108. In this way, damage to the respective unstripped sections 108 can be mitigated or prevented. The one or more light stripping elements 120 are incorporated into one or more materials of the tube body 114. For example, the one or more light stripping elements 120 may include at least one of absorbers (e.g., dopants) or scattering elements. Thus, the backward propagating light may be stripped from the capillary tube 112 by either absorption, scattering, or a combination of absorption and scattering. The one or more light stripping elements 120 may make up at least one of the one or more materials of the tube body 114. In addition, the one or more light stripping elements 120 may disperse heat along a length of the tube body 114, the heat being caused by the one or more light stripping elements 120 interacting with the backward propagating light. In the example shown in FIG. 1A, the one or more light stripping elements 120 are confined to the tapered section 118 of the tube body 114. As a result, the amount of the backward propagating light that reaches the respective unstripped sections 108 is reduced. However, the one or more light stripping elements 120 may be arranged in at least one of the tapered section 118 of the tube body 114 or the non-tapered section 116 of the tube body 114.

In some implementations, the one or more light stripping elements 120 include one or more absorbers configured to absorb backward propagating light. Thus, the one or more absorbers are incorporated into one or more materials of the tube body 114. Put another way, the one or more absorbers may make up at least one of the one or more materials of the tube body 114. In some implementations, the one or more absorbers may include one or more dopants that are diffused into the tube body 114. In some implementations, the tube body 114 may be made of one or more layers that are deposited on each other, and the one or more dopants may be incorporated into at least one of the layers of the tube body 114. For example, at least one of the layers may be a doped glass layer. In some implementations, the one or more dopants may be introduced into the tube body 114 by an ion exchange.

In examples in which the one or more absorbers include one or more dopants that are incorporated into the tube body 114, the tube body 114 may include a plurality of concentric layers that form respective rings around the plurality of fibers 106. Each absorber of the one or more absorbers may be a respective light-absorbing layer of the plurality of concentric layers. The plurality of concentric layers may include one or more doped layers configured to absorb the backward propagating light. The one or more absorbers may absorb wavelengths in an absorption band corresponding to wavelengths of the backward propagating light.

In some implementations, the plurality of concentric layers may be a plurality of concentric glass layers. The one or more dopants may be incorporated into one or more concentric glass layers of the plurality of concentric glass layers. The dopants may be added prior to or after adding a layer to the tube body 114. The plurality of concentric glass layers may include one or more undoped concentric glass layers. Thus, the one or more dopants may form a ring within the tube body 114, with the ring being formed around the plurality of fibers 106. As a result, the one or more dopants may cover a full perimeter around the internal tube volume (e.g., around the plurality of fibers 106), and may be arranged such that the one or more dopants absorb the backward propagating light regardless of the NA of the backward propagating light.

In some implementations, the one or more absorbers may be dispersed continuously along a length of the non-tapered section 116 (e.g., as shown in FIG. 1C), a length of the tapered section 118 (e.g., as shown in FIG. 1A), or respective lengths of the non-tapered section 116 and the tapered section 118 (e.g., as shown in FIG. 1B). In some implementations, the one or more absorbers may be provided in one or more localized sections of the tube body 114. For example, the one or more absorbers may be provided along a localized section of length or a localized region of the tube body 114. The one or more absorbers may disperse heat along a length of the tube body 114, a section of length of the tube body 114, and/or at localized regions of the tube body 114, the heat being caused by the one or more absorbers interacting with the backward propagating light.

In some implementations, the tube body 114 may include one or more bore holes that extend longitudinally along a length of the tube body 114, and the one or more absorbers may be arranged in the one or more bore holes. For example, each absorber of the one or more absorbers may be a doped rod arranged in (e.g., inserted into) a respective bore hole of the one or more bore holes. A doped rod may be a doped glass rod that is doped with one or more dopants. Thus, each doped rod may include one or more dopants configured to absorb the backward propagating light. The bore holes may be formed and filled before the tube body 114 is drawn and fused to the fibers 106. For example, the bore holes may be drilled into a glass preform, and the bore holes may be filled with doped material or doped rods prior to drawing the capillary tube 112 from the glass preform.

Alternatively, or additionally, the one or more light stripping elements 120 may include one or more scattering elements configured to scatter backward propagating light. Thus, the one or more scattering elements are incorporated into one or more materials of the tube body 114. Put another way, the one or more scattering elements may make up at least one of the one or more materials of the tube body 114. In some implementations, the tube body 114 may be made of one or more layers that are deposited on each other, and the one or more scattering elements may be incorporated into at least one of the layers of the tube body 114. For example, two or more layers may have different densities. The layers may be concentric layers that form respective rings around the plurality of fibers 106. As a result, the one or more scattering elements may cover a full perimeter around the internal tube volume (e.g., around the plurality of fibers 106), and may be arranged such that the one or more scattering elements scatter the backward propagating light regardless of the NA of the backward propagating light. In some implementations, the one or more scattering elements includes one or more scattering layers integrated into the tube body 114. A scattering layer may be configured to scatter light. In some implementations, the tube body 114 may be made of a substrate material having a substrate density, and the scattering layer may be made of a scattering material that has a density that is different from the substrate density. Alternatively, a scattering layer may include particles that are designed to scatter light. In some implementations, a change in density may be gradual in a radial direction of the tube body 114. Materials that have different densities may have different refractive indices and/or different porosities that may create a light scattering effect.

In examples in which the one or more light stripping elements 120 include one or more scattering elements, the tube body 114 may include a plurality of concentric layers, including two concentric layers with different densities that form a scattering element of the one or more scattering elements. For example, the two concentric layers may form one or more light scattering boundaries based on a difference in densities of the two concentric layers. The one or more light scattering boundaries may encircle the internal tube volume such that the light scattering boundaries scatter the backward propagating light regardless of the NA of the backward propagating light.

In some implementations, the tube body 114 includes a plurality of layers (e.g., two or more layers) having different densities. The plurality of layers may be glass layers with different densities. The plurality of layers may form one or more light scattering boundaries based on a difference in densities between adjacent layers of the plurality of layers, with the one or more light scattering boundaries forming the one or more scattering elements. Thus, multiple light scattering boundaries may be formed. Thus, the tube body 114 may have a varied density that varies along a radial dimension of the tube body 114, and the varied density may form the one or more scattering elements. The varied density may vary as a function of a radius of the tube body 114. For example, the varied density may change along the radial dimension of the tube body 114.

In some implementations, the tube body 114 may have a varied refractive index that changes along a radial dimension of the tube body 114, and the varied refractive index may form the one or more scattering elements. In some examples, the varied refractive index may be accomplished by using a plurality of concentric layers that have different refractive indices.

In some examples, each successive layer of a plurality of concentric layers may have a higher density than a previous layer, such that the density of the tube body 114 increases in a radial dimension. Alternatively, each successive layer of a plurality of concentric layers may have a lower density than a previous layer, such that the density of the tube body 114 decreases in a radial dimension.

In some implementations, the tube body 114 may include one or more bore holes that extend longitudinally along a length of the tube body 114, and the one or more scattering elements may be arranged in the one or more bore holes. For example, each scattering element of the one or more scattering elements may be a rod arranged in (e.g., inserted into) a respective bore hole of the one or more bore holes. The tube body 114 may be made of a substrate material having a substrate density. Each rod may have a respective density that is different from the substrate density. In other words, each rod may be formed of a respective scattering material. Thus, each rod may produce a light scattering effect based on a difference in density relative to the substrate density. The bore holes may be formed and filled before the tube body 114 is drawn and fused to the fibers 106. For example, the bore holes may be drilled into a glass preform, and the bore holes may be filled with scattering material prior to drawing the capillary tube 112 from the glass preform.

In some implementations, the one or more scattering elements may be dispersed continuously along a length of the non-tapered section 116 (e.g., as shown in FIG. 1C), a length of the tapered section 118 (e.g., as shown in FIG. 1A), or respective lengths of the non-tapered section 116 and the tapered section 118 (e.g., as shown in FIG. 1B). In some implementations, the one or more scattering elements may be provided in one or more localized sections of the tube body 114. For example, the one or more scattering elements may be provided along a localized section of a length or a localized region of the tube body 114. The one or more scattering elements may disperse heat along a length of the tube body 114, a section of length of the tube body 114, and/or at localized regions of the tube body 114, the heat being caused by the one or more scattering elements interacting with the backward propagating light.

Capillary tubes used in combiners may have an outside diameter of a few millimeters and may be produced from larger tubes that are manufactured using chemical vapor deposition (CVD) processes. These CVD processes may be used to produce capillary tubes and glass rods. The CVD processes may include modified chemical vapor deposition (MCVD), vapor axial deposition (VAD), outside vapor deposition (OVD), and plasma chemical vapor deposition (PCVD) processes.

In these CVD processes, layers of doped or undoped silica may be deposited either on the external surface of a target or a mandrel (OVD and VAD) or on an internal surface of a glass substrate tube (MCVD and PCVD). By precisely controlling flow rates of precursor gases and process parameters such as temperature, carrier gas composition, and deposition time, a dopant concentration and/or a density of the glass can be accurately managed both radially and longitudinally along the length of the capillary tube 112.

At this fabrication stage, the outer diameter (OD) of the capillary tube is typically not suitable for direct use in building optical combiners. The capillary tube can be pre-collapsed and/or stretched directly on a lathe or drawn into capillaries using a draw tower. In this latter method, the capillary tube is fed into a furnace and drawn out while maintaining control over its internal pressure to achieve the desired dimensions. Additional fabrication methods beyond OVD, VAD, MCVD, and PCVD may also be utilized to create glass layers with varying dopant concentrations.

For the fabrication of doped rods intended as inserts, similar vapor deposition processes can be applied. These doped rods can then be assembled with other rods and subsequently drawn into the capillary tube. Additionally, the doped inserts can be placed within a pre-drilled capillary tube before a final drawing process.

For the fabrication of scattering rods intended as inserts, glass rods may be formed that have a different density than a density of the glass substrate tube. These scattering rods can then be assembled with other rods and subsequently drawn into the capillary tube. Additionally, the scattering inserts can be placed within a pre-drilled capillary tube before a final drawing process.

As indicated above, FIG. 1A is provided as an example. Other examples may differ from what is described with regard to FIG. 1A.

FIG. 1B shows a light combiner assembly 100B according to one or more implementations. The light combiner assembly 100B may be similar to the light combiner assembly 100A described in connection with FIG. 1A, except that the one or more light stripping elements 120 extend along an entire length of the tube body 114 and the respective unstripped sections 108 are arranged outside of the capillary tube 112. Thus, the one or more light stripping elements 120 are incorporated into respective lengths of the non-tapered section 116 and the tapered section 118. As a result, the amount of the backward propagating light that reaches the respective unstripped sections 108 is reduced.

As indicated above, FIG. 1B is provided as an example. Other examples may differ from what is described with regard to FIG. 1B.

FIG. 1C shows a light combiner assembly 100C according to one or more implementations. The light combiner assembly 100C may be similar to the light combiner assembly 100B described in connection with FIG. 1B, except that the one or more light stripping elements 120 may be confined to the non-tapered section 116 of the tube body 114. As a result, the amount of the backward propagating light that reaches the respective unstripped sections 108 is reduced.

As indicated above, FIG. 1C is provided as an example. Other examples may differ from what is described with regard to FIG. 1C.

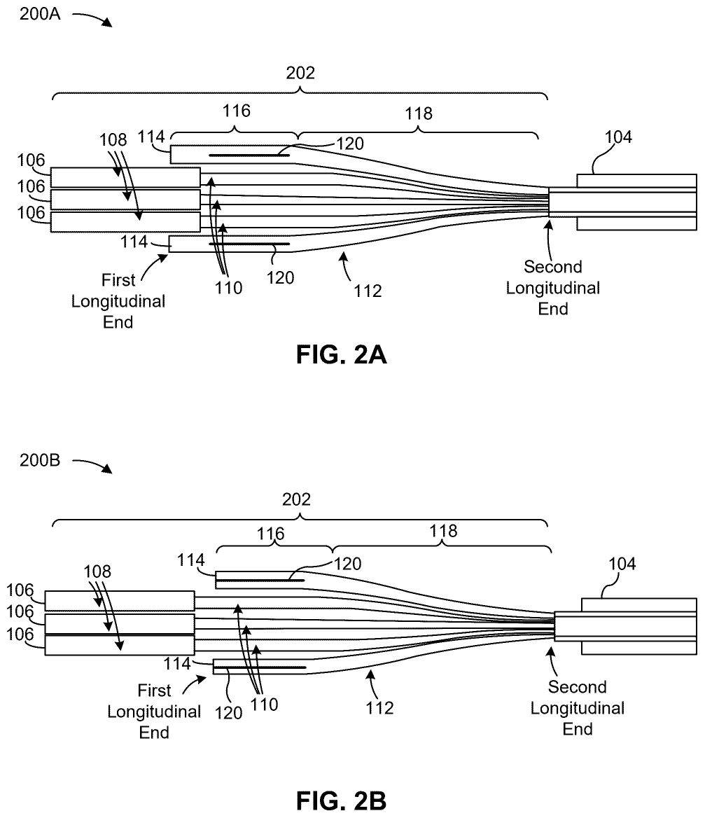

FIG. 2A shows a light combiner assembly 200A according to one or more implementations. The light combiner assembly 200A may include a combiner 202 and an output fiber 104 that is spliced to the combiner 202 for receiving forward propagating light traveling in a forward propagating direction (e.g., from left-to-right). In addition, the combiner 202 may receive backward propagating light from the output fiber 104 that travels in a backward propagating direction (e.g., from right-to-left). The combiner 202 may be a pump combiner or a pump and signal combiner.

The combiner 202 may be similar to the combiner 102 described in connection with FIG. 1A, except that the one or more light stripping elements 120 may be confined to the non-tapered section 116 of the tube body 114. In a pump combiner or a pump and signal combiner, the tapered section 118 of the tube body 114 may be used as a waveguide for pump light traveling in the forward direction. Thus, having one or more light stripping elements 120 in the tapered section 118 of the tube body 114 may be undesirable, since the one or more light stripping elements 120 located in the tapered section 118 may strip the pump light (e.g., desired or useful light) out of the capillary tube 112. In contrast, in a signal combiner, the capillary tube 112 is not used as a waveguide. Thus, in a signal combiner, one or more light stripping elements 120 may be arranged in the non-tapered section 116 and/or the tapered section 118, as demonstrated in FIGS. 1A-1C. In both cases, the one or more light stripping elements 120 may reduce the amount of backward propagating light that reaches the respective unstripped sections 108, thereby protecting the respective unstripped sections 108 from damage from backward propagating light traveling through the capillary tube 112 in the backward direction.

As indicated above, FIG. 2A is provided as an example. Other examples may differ from what is described with regard to FIG. 2A.

FIG. 2B shows a light combiner assembly 200B according to one or more implementations. The light combiner assembly 200B may be similar to the light combiner assembly 200A described in connection with FIG. 2A, except that the respective unstripped sections 108 are arranged outside of the capillary tube 112. The one or more light stripping elements 120 may reduce the amount of backward propagating light that reaches the respective unstripped sections 108, thereby protecting the respective unstripped sections 108 from damage from backward propagating light traveling through the capillary tube 112 in the backward direction.

As indicated above, FIG. 2B is provided as an example. Other examples may differ from what is described with regard to FIG. 2B.

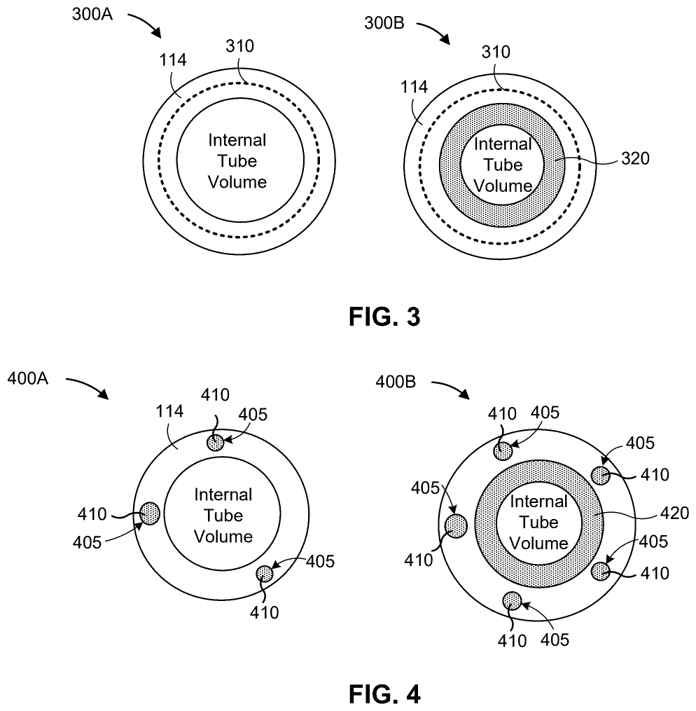

FIG. 3 shows cross-sections of capillary tubes 300A and 300B taken along a radial axis. The capillary tubes 300A and 300B include a tube body 114 made of a substrate material (e.g., silicon dioxide glass). A light stripping ring 310 may be incorporated into the tube body 114 of each capillary tube 300A and 300B. The light stripping ring 310 may be a doped ring of absorbers or a scattering ring, as described in connection with FIGS. 1A, 1B, 1C, 2A, and 2B. Additionally, the capillary tube 300B may include an inner doped glass layer 320 configured to lower the NA and confine light.

As indicated above, FIG. 3 is provided as an example. Other examples may differ from what is described with regard to FIG. 3.

FIG. 4 shows cross-sections of capillary tubes 400A and 400B taken along a radial axis. The capillary tubes 400A and 400B include a tube body 114 made of a substrate material (e.g., silicon dioxide glass). Bore holes 405 may be formed in the tube body of each capillary tube 300A and 300B. The bore holes 405 may be filled with a light stripping element 410, such as a doped rod of absorbers or a scattering rod, as described in connection with FIGS. 1A, 1B, 1C, 2A, and 2B. Additionally, the capillary tube 300B may include an inner doped glass layer 420 configured to lower the NA and confine light.

As indicated above, FIG. 4 is provided as an example. Other examples may differ from what is described with regard to FIG. 4.

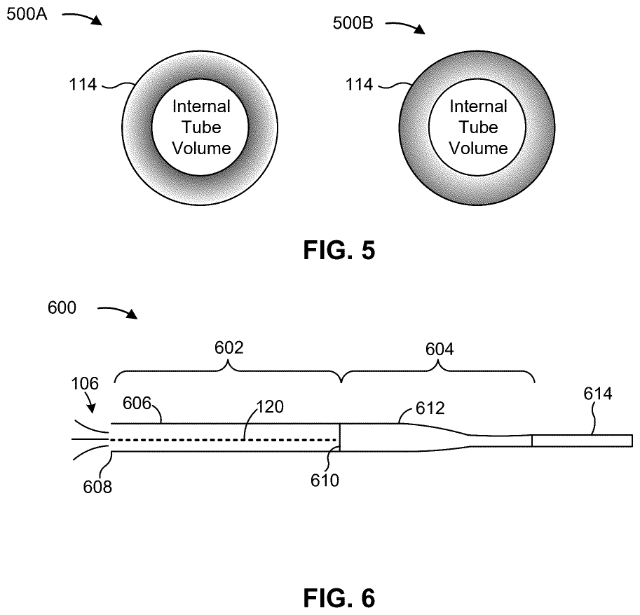

FIG. 5 shows cross-sections of capillary tubes 500A and 500B taken along a radial axis. The capillary tubes 500A and 500B include a tube body 114 that has a varied density that varies along a radial dimension of the tube body 114. The varied density may form the one or more scattering elements. The varied density may vary as a function of a radius of the tube body 114. For example, the varied density may gradually change along the radial dimension of the tube body 114. In the capillary tube 500A, a density of the tube body 114 may decrease from an inner diameter to an outer diameter of the tube body 114. In the capillary tube 500B, a density of the tube body 114 may increase from an inner diameter to an outer diameter of the tube body 114.

As indicated above, FIG. 5 is provided as an example. Other examples may differ from what is described with regard to FIG. 5.

FIG. 6 shows a cross-section of a light combiner assembly 600 taken along a longitudinal axis according to one or more implementations. The light combiner assembly 600 may include a plurality of fibers 106 that form a fiber bundle. The plurality of fibers 106 may have respective unstripped sections and respective stripped sections, as described in connection with FIG. 1A. The plurality of fibers 106 may receive light from a plurality of respective light sources and combine the light into forward propagating light. The light combiner assembly 600 may also include a non-tapered capillary tube 602 and a tapered capillary tube 604.

The non-tapered capillary tube 602 may include a first tube body 606 that defines a first internal tube volume in which the plurality of fibers 106 is arranged. The respective stripped sections of the plurality of fibers 106 may be fused to the first tube body 606, within the first internal tube volume. The first tube body 606 includes a first longitudinal end 608 arranged proximate to the respective unstripped sections, and a second longitudinal end 610. In addition, the first tube body 606 may include one or more light stripping elements 120, such as absorbers or scattering elements, configured to strip backward propagating light out of the non-tapered capillary tube 602 through absorption and/or scattering. The one or more light stripping elements 120 may be incorporated into one or more materials of the first tube body 606, as described in connection with FIG. 1A.

The tapered capillary tube 604 includes a second tube body 612 that defines a second internal tube volume. The second tube body 612 may be spliced to the second longitudinal end 610 of the first tube body 606 for receiving the forward propagating light from the non-tapered capillary tube 602. The second tube body 612 may be substantially devoid of light stripping elements. An output fiber 614 may be spliced to the second tube body 612 for receiving the forward propagating light from the tapered capillary tube 604.

In some implementations, the light combiner assembly 600 may be a pump combiner or a pump and signal combiner in which the tapered capillary tube 604 is configured to guide pump light in the forward direction. Thus, it may be undesirable to include light stripping elements 120 in the tapered capillary tube 604 such that the pump light is not stripped from the tapered capillary tube 604.

In some implementations, light stripping elements 120 are included in the tapered capillary tube 604.

As indicated above, FIG. 6 is provided as an example. Other examples may differ from what is described with regard to FIG. 6.

The following provides an overview of some Aspects of the present disclosure:

Aspect 1: A light combiner assembly, comprising: a plurality of fibers that form a fiber bundle, wherein the plurality of fibers have respective unstripped sections and respective stripped sections, wherein the plurality of fibers are configured to receive light from a plurality of respective light sources and combine the light into forward propagating light; and a capillary tube that includes a tube body that defines an internal tube volume in which the plurality of fibers is arranged, wherein the tube body includes a non-tapered section, including a first longitudinal end arranged proximate to the respective unstripped sections, and a tapered section, including a second longitudinal end, arranged around the respective stripped sections and to which the respective stripped sections are fused, wherein the tapered section tapers from a first tube diameter of the non-tapered section to a second tube diameter of the second longitudinal end, wherein the tube body includes one or more scattering elements configured to scatter backward propagating light, and wherein the one or more scattering elements are incorporated into one or more materials of the tube body.

Aspect 2: The light combiner assembly of Aspect 1, wherein the one or more scattering elements make up at least one of the one or more materials of the tube body.

Aspect 3: The light combiner assembly of any of Aspects 1-2, wherein the one or more scattering elements are arranged in at least one of the tapered section of the tube body or the non-tapered section of the tube body.

Aspect 4: The light combiner assembly of any of Aspects 1-3, wherein the one or more scattering elements are confined to the non-tapered section of the tube body.

Aspect 5: The light combiner assembly of any of Aspects 1-4, wherein the one or more scattering elements are confined to the tapered section of the tube body.

Aspect 6: The light combiner assembly of any of Aspects 1-5, wherein the one or more scattering elements are configured to reduce an amount of the backward propagating light that reaches the respective unstripped sections of the plurality of fibers.

Aspect 7: The light combiner assembly of any of Aspects 1-6, wherein the one or more scattering elements are provided continuously along a length of the non-tapered section, a length of the tapered section, or respective lengths of the non-tapered section and the tapered section.

Aspect 8: The light combiner assembly of any of Aspects 1-7, wherein the one or more scattering elements are provided in one or more localized sections of the tube body.

Aspect 9: The light combiner assembly of any of Aspects 1-8, wherein the one or more scattering elements are configured to disperse heat along a length of the tube body, the heat being caused by the one or more scattering elements interacting with the backward propagating light.

Aspect 10: The light combiner assembly of any of Aspects 1-9, wherein the tube body includes a plurality of concentric layers, including two concentric layers with different densities that form a scattering element of the one or more scattering elements.

Aspect 11: The light combiner assembly of any of Aspects 1-10, wherein the tube body includes a plurality of layers having different densities, and wherein the plurality of layers form one or more light scattering boundaries based on a difference in densities between adjacent layers of the plurality of layers, the one or more light scattering boundaries forming the one or more scattering elements.

Aspect 12: The light combiner assembly of any of Aspects 1-11, wherein the tube body has a varied density that varies along a radial dimension of the tube body, and wherein the varied density forms the one or more scattering elements.

Aspect 13: The light combiner assembly of Aspect 12, wherein the varied density varies as a function of a radius of the tube body.

Aspect 14: The light combiner assembly of Aspect 12, wherein the varied density gradually changes along the radial dimension of the tube body.

Aspect 15: The light combiner assembly of any of Aspects 1-14, wherein the tube body has a varied refractive index that changes along a radial dimension of the tube body, and wherein the varied refractive index forms the one or more scattering elements.

Aspect 16: The light combiner assembly of any of Aspects 1-15, wherein the one or more scattering elements includes one or more scattering layers integrated into the tube body.

Aspect 17: The light combiner assembly of any of Aspects 1-16, wherein the tube body includes one or more bore holes that extend longitudinally along a length of the tube body, and wherein the one or more scattering elements are arranged in the one or more bore holes.

Aspect 18: The light combiner assembly of Aspect 17, wherein the tube body is made of a substrate material having a substrate density, wherein each scattering element of the one or more scattering elements is a rod arranged in a respective bore hole of the one or more bore holes, and wherein each rod has a respective density that is different from the substrate density.

Aspect 19: The light combiner assembly of any of Aspects 1-18, wherein the tube body includes one or more absorbers configured to absorb backward propagating light.

Aspect 20: A light combiner assembly, comprising: a plurality of fibers that form a fiber bundle, wherein the plurality of fibers have respective unstripped sections and respective stripped sections, wherein the plurality of fibers are configured to receive light from a plurality of respective light sources and combine the light into forward propagating light; and a non-tapered capillary tube that includes a first tube body that defines a first internal tube volume in which the plurality of fibers is arranged, wherein the respective stripped sections are fused to the first tube body, wherein the first tube body includes a first longitudinal end arranged proximate to the respective unstripped sections, and a second longitudinal end, wherein the first tube body includes one or more scattering elements configured to scatter backward propagating light, and wherein the one or more scattering elements are incorporated into one or more materials of the first tube body; and a tapered capillary tube that includes a second tube body that defines a second internal tube volume, wherein the second tube body is spliced to the second longitudinal end of the first tube body for receiving the forward propagating light from the non-tapered capillary tube.

Aspect 21: The light combiner assembly of Aspect 20, wherein the second tube body is substantially devoid of scattering elements.

Aspect 22: The light combiner assembly of any of Aspects 20-21, further comprising: an output fiber spliced to the second tube body for receiving the forward propagating light from the tapered capillary tube.

Aspect 23: A system configured to perform one or more operations recited in one or more of Aspects 1-22.

Aspect 24: An apparatus comprising means for performing one or more operations recited in one or more of Aspects 1-22.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A light combiner assembly, comprising:
a plurality of fibers that form a fiber bundle, wherein the plurality of fibers have respective unstripped sections and respective stripped sections, wherein the plurality of fibers are configured to receive light from a plurality of respective light sources and combine the light into forward propagating light; and
a capillary tube that includes a tube body that defines an internal tube volume in which the plurality of fibers is arranged,
wherein the tube body includes a non-tapered section, including a first longitudinal end arranged proximate to the respective unstripped sections, and a tapered section, including a second longitudinal end, arranged around the respective stripped sections and to which the respective stripped sections are fused,
wherein the tapered section tapers from a first tube diameter of the non-tapered section to a second tube diameter of the second longitudinal end,
wherein the tube body includes one or more scattering elements configured to scatter backward propagating light, and
wherein the one or more scattering elements are incorporated into one or more materials of the tube body.

2. The light combiner assembly of claim 1, wherein the one or more scattering elements make up at least one of the one or more materials of the tube body.

3. The light combiner assembly of claim 1, wherein the one or more scattering elements are arranged in at least one of the tapered section of the tube body or the non-tapered section of the tube body.

4. The light combiner assembly of claim 1, wherein the one or more scattering elements are confined to the non-tapered section of the tube body.

5. The light combiner assembly of claim 1, wherein the one or more scattering elements are confined to the tapered section of the tube body.

6. The light combiner assembly of claim 1, wherein the one or more scattering elements are configured to reduce an amount of the backward propagating light that reaches the respective unstripped sections of the plurality of fibers.

7. The light combiner assembly of claim 1, wherein the one or more scattering elements are provided continuously along a length of the non-tapered section, a length of the tapered section, or respective lengths of the non-tapered section and the tapered section.

8. The light combiner assembly of claim 1, wherein the one or more scattering elements are provided in one or more localized sections of the tube body.

9. The light combiner assembly of claim 1, wherein the one or more scattering elements are configured to disperse heat along a length of the tube body, the heat being caused by the one or more scattering elements interacting with the backward propagating light.

10. The light combiner assembly of claim 1, wherein the tube body includes a plurality of concentric layers, including two concentric layers with different densities that form a scattering element of the one or more scattering elements.

11. The light combiner assembly of claim 1, wherein the tube body includes a plurality of layers having different densities, and
wherein the plurality of layers form one or more light scattering boundaries based on a difference in densities between adjacent layers of the plurality of layers, the one or more light scattering boundaries forming the one or more scattering elements.

12. The light combiner assembly of claim 1, wherein the tube body has a varied density that varies along a radial dimension of the tube body, and
wherein the varied density forms the one or more scattering elements.

13. The light combiner assembly of claim 12, wherein the varied density varies as a function of a radius of the tube body.

14. The light combiner assembly of claim 12, wherein the varied density gradually changes along the radial dimension of the tube body.

15. The light combiner assembly of claim 1, wherein the tube body has a varied refractive index that changes along a radial dimension of the tube body, and
wherein the varied refractive index forms the one or more scattering elements.

16. The light combiner assembly of claim 1, wherein the one or more scattering elements includes one or more scattering layers integrated into the tube body.

17. The light combiner assembly of claim 1, wherein the tube body includes one or more bore holes that extend longitudinally along a length of the tube body, and
wherein the one or more scattering elements are arranged in the one or more bore holes.

18. The light combiner assembly of claim 17, wherein the tube body is made of a substrate material having a substrate density,
wherein each scattering element of the one or more scattering elements is a rod arranged in a respective bore hole of the one or more bore holes, and
wherein each rod has a respective density that is different from the substrate density.

19. The light combiner assembly of claim 1, wherein the tube body includes one or more absorbers configured to absorb backward propagating light.

20. A light combiner assembly, comprising:
a plurality of fibers that form a fiber bundle, wherein the plurality of fibers have respective unstripped sections and respective stripped sections, wherein the plurality of fibers are configured to receive light from a plurality of respective light sources and combine the light into forward propagating light; and
a non-tapered capillary tube that includes a first tube body that defines a first internal tube volume in which the plurality of fibers is arranged,
wherein the respective stripped sections are fused to the first tube body,
wherein the first tube body includes a first longitudinal end arranged proximate to the respective unstripped sections, and a second longitudinal end,
wherein the first tube body includes one or more scattering elements configured to scatter backward propagating light, and
wherein the one or more scattering elements are incorporated into one or more materials of the first tube body; and
a tapered capillary tube that includes a second tube body that defines a second internal tube volume,
wherein the second tube body is spliced to the second longitudinal end of the first tube body for receiving the forward propagating light from the non-tapered capillary tube.

21. The light combiner assembly of claim 20, wherein the second tube body is substantially devoid of scattering elements.

22. The light combiner assembly of claim 20, further comprising:
an output fiber spliced to the second tube body for receiving the forward propagating light from the tapered capillary tube.
